(19) United States
(12) Patent Application Publication
(10) Pub. No.: US 2014/0092740 A1
(43) Pub. Date: Apr. 3, 2014

(54) ADAPTIVE PACKET DEFLECTION TO ACHIEVE FAIR, LOW-COST, AND/OR ENERGY-EFFICIENT QUALITY OF SERVICE IN NETWORK ON CHIP DEVICES

(71) Applicants: Ren Wang, Portland, OR (US); Ahmad Samih, Beaverton, OR (US); Christian Maciocco, Portland, OR (US); Tsung-Yuan Tai, Portland, OR (US)

(72) Inventors: Ren Wang, Portland, OR (US); Ahmad Samih, Beaverton, OR (US); Christian Maciocco, Portland, OR (US); Tsung-Yuan Tai, Portland, OR (US)

(21) Appl. No.: 13/631,878

(22) Filed: Sep. 29, 2012

(51) Int. Cl. H04L 12/70

(52) U.S. Cl. CPC H04L 47/24
USPC 370/235

(57) ABSTRACT

Methods and apparatus for provision of adaptive packet deflection to achieve fair, low-cost, and/or energy-efficient Quality of Service (QoS) in Network-on-Chip (NoC) devices are described. In some embodiments, it is determined whether a target port of a packet has reached a threshold utilization value and the packet is routed to an alternate port in response to a deflection probability value that is to be determined based on a utilization value of the target port and a priority level value of the packet. Other embodiments are also claimed and/or disclosed.

### FIELD

The present disclosure generally relates to the field of electronics. More particularly, an embodiment of the invention relates to techniques for provision of adaptive packet deflection to achieve fair, low-cost, and/or energy-efficient Quality of Service (QoS) in Network-on-Chip (NoC) devices.

### BACKGROUND

Some current interconnection networks are used to connect many computing components such as many cores in Chip Multi Processors (CMPs) and many-nodes in clustered systems. Some Network-on-Chip (NoC) prototypes with high core count show that NoCs consume a substantial portion of overall system power. Moreover, with such systems, there can be a diverse set of applications running simultaneously on multiple cores/nodes and the interconnect acts as a shared medium, servicing requests from these cores. As a result, at any given instance, there may exist multiple packet classes (data and control) that belong to multiple applications, originating from different cores/nodes. Each of these packets can have different Quality-of-Service (QoS) requirements. This means that the interconnect policy should be able to support multiple traffic classes, so that the packets that belong to a higher priority class are served with certain QoS requirement (e.g., faster delivery time).

Current NoC-QoS approaches can be lumped into two main categories. First, QoS can be achieved by introducing additional queues to the router (e.g., extra virtual channels), assigning different classes of packets to these different queues, and serving them with different priorities. Although adding additional buffering/queues guarantee (at least to some extent) that all packets are routed through minimum paths, it significantly increases the power budget and associated costs of the interconnect. The second category of NoC-QoS approaches, on the other hand, do not necessarily add additional buffering; however, they require major changes to the router architecture such that the router, instead of maintaining FIFO (First In First Out) queues, is able to pull out any packet from the available queues in any order, and service it based on its priority level. This, therefore, increases the complexity of the interconnect and even worse, it increases its power consumption and cost as well.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of an embodiment of a computing system, which may be utilized to implement various embodiments discussed herein.

FIG. 2 illustrates a block diagram of an embodiment of a computing system, which may be utilized to implement various embodiments discussed herein.

FIG. 3 is a block diagram of a routing and switching logic, in accordance with an embodiment.

FIG. 4 illustrates a flow diagram of a method for a selective deflection policy for QoS support, according to some embodiments.

FIG. 5 illustrates a block diagram of an embodiment of a computing system, which may be utilized to implement various embodiments discussed herein.

FIG. 6 illustrates a block diagram of an embodiment of a computing system, which may be utilized to implement various embodiments discussed herein.

### DETAILED DESCRIPTION

In the following description, numerous specific details are set forth in order to provide a thorough understanding of various embodiments. However, some embodiments may be practiced without the specific details. In other instances, well-known methods, procedures, components, and circuits have not been described in detail so as not to obscure the particular embodiments. Various aspects of embodiments of the invention may be performed using various means, such as integrated semiconductor circuits (“hardware”), computer-readable instructions organized into one or more programs (“software”) or some combination of hardware and software. For the purposes of this disclosure reference to “logic” shall mean either hardware, software, or some combination thereof.

Some embodiments improve the quality and/or performance of high-speed serial I/O channels via various techniques. For example, such techniques are used to provide adaptive packet deflection to achieve fair, low-cost, and/or energy-efficient Quality of Service (QoS) in Network-on-Chip (NoC) devices. As a result, interconnects may be able to support QoS traffic without an increase in power consumption and/or silicon area. Furthermore, some embodiments provide QoS for Network-on-Chips, without changing the router architecture, or requiring support of multiple queues, while at the same time maintaining high overall throughput.

Also, some embodiments are used for both many-core processors and systems with many nodes (such as μCluster based systems), allowing energy efficient and high performance interconnects that could fit within a target power budget. Moreover, QoS support (e.g., without queues used in some current implementations), relatively simple router architecture (resulting in no or little increase in silicon area and without major changes to the router architecture), and/or less buffering area and power consumption (e.g., since the additional queues used in some current implementation are not used).

In an embodiment, NoC and/or QoS support is provided via selectively deflecting low priority packets to avoid/reduce congestion and to guarantee the timely delivery of high priority packets. By selectively deflecting packets, one embodiment does not require any additional buffering, nor does it demand changing of the router architecture; thus, it is capable of achieving QoS with minimal buffering area, and simple router architectures, in various systems such as NoC. This, in turn, reduces the interconnect cost and power consumption. Also, in an embodiment, the interconnect(s) discussed herein are implemented in accordance with PCI Express Base Specification 3.0, Revision 3.0, version 1.0 Nov. 10, 2010 and Errata for the PCI Express Base Specification Revision 3.0, Oct. 20, 2011.

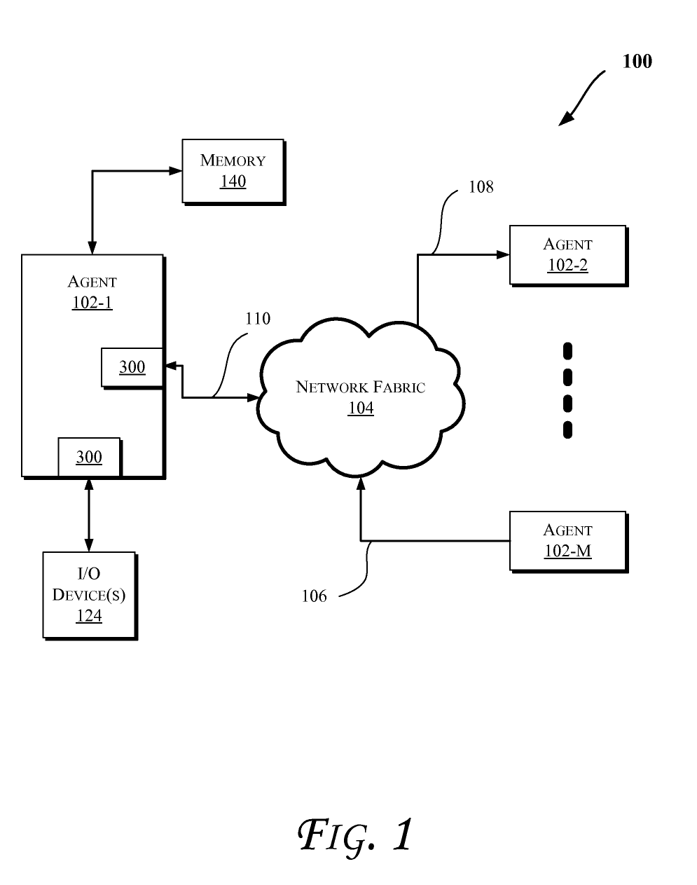

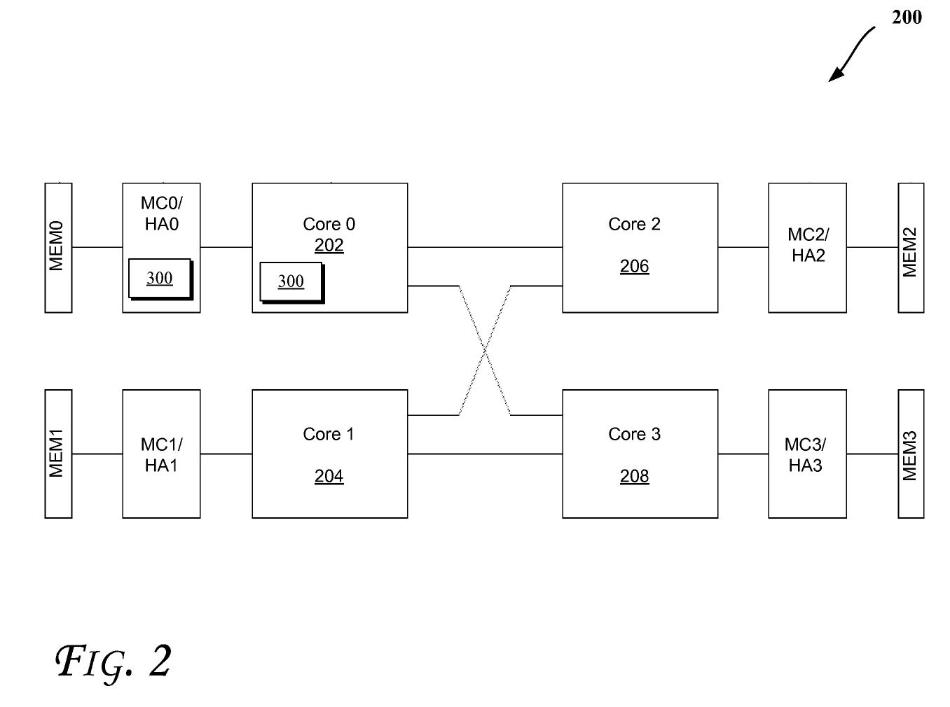

Various embodiments are discussed herein with reference to a computing system component, such as the components discussed herein, e.g., with reference to FIGS. 1-2 and 5-6. More particularly, FIG. 1 illustrates a block diagram of a computing system 100, according to an embodiment of the invention. The system 100 includes one or more agents 102-1 through 102-M (collectively referred to herein as “agents 102” or more generally “agent 102”). In an embodiment, the agents 102 are components of a computing system, such as the computing systems discussed with reference to FIGS. 2 and 5-6.

As illustrated in FIG. 1, the agents 102 communicate via a network fabric 104. In an embodiment, the network fabric 104 can include one or more interconnects (or interconnection networks) that communicate via a serial (e.g., point-to-point) link and/or a shared communication network. For example, some embodiments can facilitate component debug or validation on links that allow communication with fully buffered dual in-line memory modules (FBD), e.g., where the FBD link is a serial link for coupling memory modules to a host controller device (such as a processor or memory hub). Debug information may be transmitted from the FBD channel host such that the debug information is observed along the channel by channel traffic trace capture tools (such as one or more logic analyzers).

In one embodiment, the system 100 can support a layered protocol scheme, which includes a physical layer, a link layer, a routing layer, a transport layer, and/or a protocol layer. The fabric 104 can further facilitate transmission of data (e.g., in form of packets) from one protocol (e.g., caching processor or caching aware memory controller) to another protocol for a point-to-point network. Also, in some embodiments, the network fabric 104 can provide communication that adheres to one or more cache coherent protocols.

Furthermore, as shown by the direction of arrows in FIG. 1, the agents 102 transmit and/or receive data via the network fabric 104. Hence, some agents utilize a unidirectional link while others utilize a bidirectional link for communication. For instance, one or more agents (such as agent 102-M) transmit data (e.g., via a unidirectional link 106), other agent(s) (such as agent 102-2) receive data (e.g., via a unidirectional link 108), while some agent(s) (such as agent 102-1) both transmit and receive data (e.g., via a bidirectional link 110).

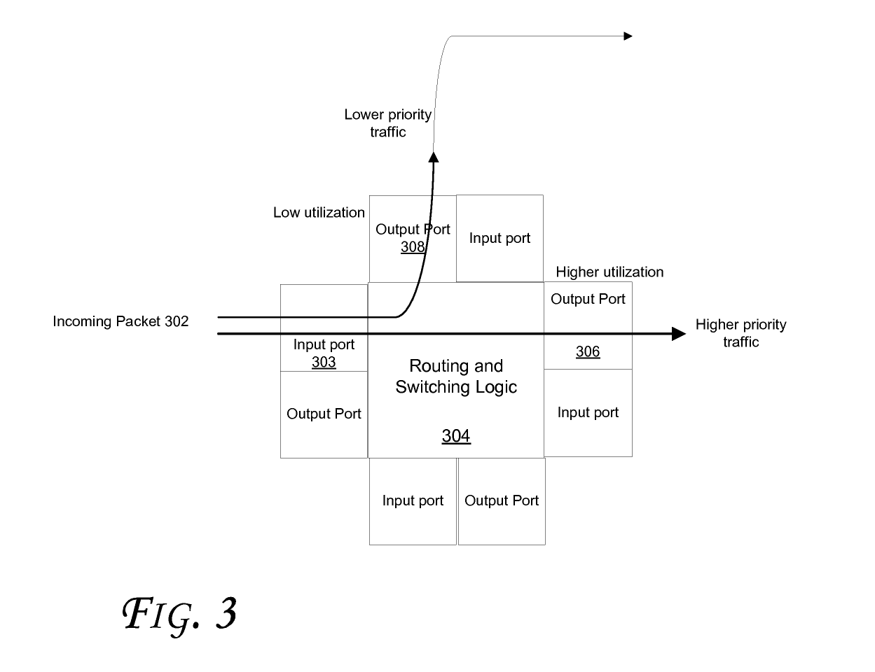

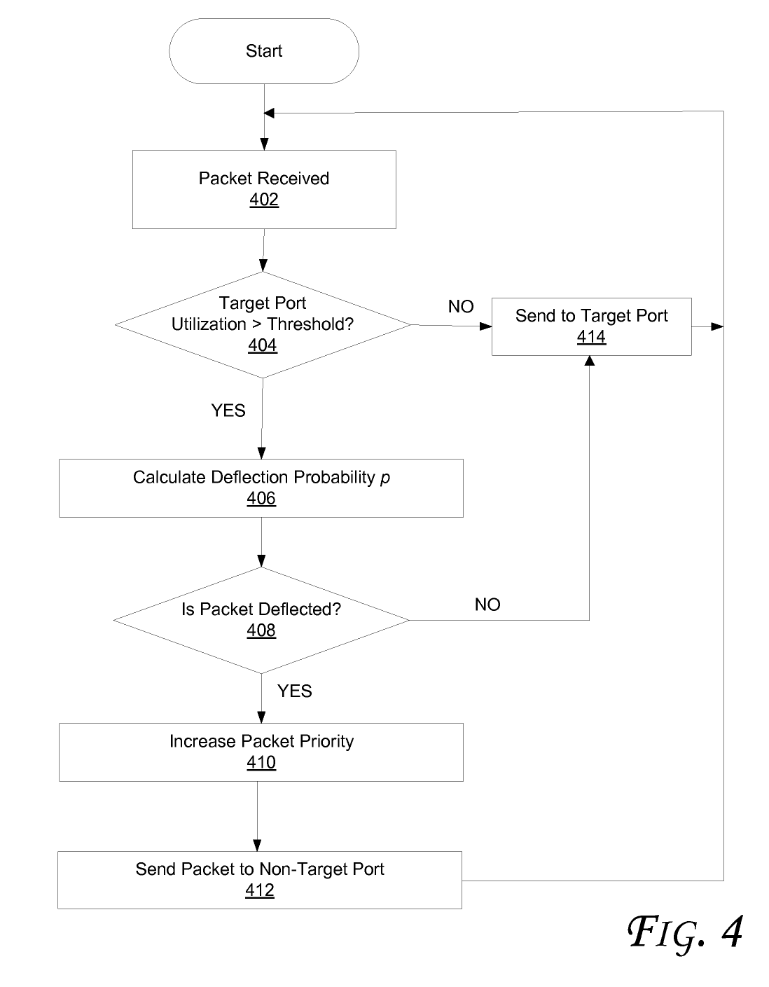

Also, in accordance with an embodiment, one or more of the agents 102 include one or more routing and switching logic 300 to facilitate communication between an agent (e.g., agent 102-1 shown) and one or more Input/Output (“I/O” or “IO”) devices 124 (such as Peripheral Component Interconnect Express (PCIe) I/O devices, which operate in accordance with PCI Express Base Specification 3.0, Revision 3.0, version 1.0 Nov. 10, 2010 and Errata for the PCI Express Base Specification Revision 3.0, Oct. 20, 2011) and/or other agents coupled via the fabric 104 as will be further discussed herein (e.g., with reference to FIGS. 3-4). Also, while FIG. 1 illustrates logic 300 to be included in the agent 102-1, logic 300 can be located elsewhere in the system 100, such as within I/O device(s) 124, as part of or another device (such as a network router) coupled to the network fabric 104.

FIG. 2 is a block diagram of a computing system 200 in accordance with an embodiment. System 200 includes a plurality of sockets 202-208 (four shown but some embodiments can have more or less socket). Each socket includes a processor and one or more routing and switching logic 300. In some embodiments, one or more routing and switching logic 300 can be present in one or more components of system 200 (such as those shown in FIG. 2). Additionally, each socket is coupled to the other sockets via a point-to-point (PtP) link, or a differential interconnect, such as a Quick Path Interconnect (QPI), MIPI (Mobile Industry Processor Interface), etc. As discussed with respect the network fabric 104 of FIG. 1, each socket is coupled to a local portion of system memory, e.g., formed by a plurality of Dual Inline Memory Modules (DIMMs) that includes dynamic random access memory (DRAM).

In another embodiment, the network fabric may be utilized for any System on Chip (SoC) application, utilize custom or standard interfaces, such as, ARM compliant interfaces for AMBA (Advanced Microcontroller Bus Architecture), OCP (Open Core Protocol), MIPI (Mobile Industry Processor Interface), PCI (Peripheral Component Interconnect) or PCIe (Peripheral Component Interconnect Express).

Some embodiments use a technique that enables use of heterogeneous resources, such as AXI/OCP technologies, in a PC (Personal Computer) based system such as a PCI-based system without making any changes to the IP resources themselves. Embodiments provide two very thin hardware blocks, referred to herein as a Yunit and a shim, that can be used to plug AXI/OCP IP into an auto-generated interconnect fabric to create PCI-compatible systems. In one embodiment a first (e.g., a north) interface of the Yunit connects to an adapter block that interfaces to a PCI-compatible bus such as a direct media interface (DMI) bus, a PCI bus, or a Peripheral Component Interconnect Express (PCIe) bus. A second (e.g., south) interface connects directly to a non-PC interconnect, such as an AXI/OCP interconnect. In various implementations, this bus may be an OCP bus.

In some embodiments, the Yunit implements PCI enumeration by translating PCI configuration cycles into transactions that the target IP can understand. This unit also performs address translation from re-locatable PCI addresses into fixed AXI/OCP addresses and vice versa. The Yunit may further implement an ordering mechanism to satisfy a producer-consumer model (e.g., a PCI producer-consumer model). In turn, individual IPs are connected to the interconnect via dedicated PCI shims. Each shim may implement the entire PCI header for the corresponding IP. The Yunit routes all accesses to the PCI header and the device memory space to the shim. The shim consumes all header read/write transactions and passes on other transactions to the IP. In some embodiments, the shim also implements all power management related features for the IP.

Thus, rather than being a monolithic compatibility block, embodiments that implement a Yunit take a distributed approach. Functionality that is common across all IPs, e.g., address translation and ordering, is implemented in the Yunit, while IP-specific functionality such as power management, error handling, and so forth, is implemented in the shims that are tailored to that IP.

In this way, a new IP can be added with minimal changes to the Yunit. For example, in one implementation the changes may occur by adding a new entry in an address redirection table. While the shims are IP-specific, in some implementations a large amount of the functionality (e.g., more than 90%) is common across all IPs. This enables a rapid reconfiguration of an existing shim for a new IP. Some embodiments thus also enable use of auto-generated interconnect fabrics without modification. In a point-to-point bus architecture, designing interconnect fabrics can be a challenging task. The Yunit approach described above leverages an industry ecosystem into a PCI system with minimal effort and without requiring any modifications to industry-standard tools.

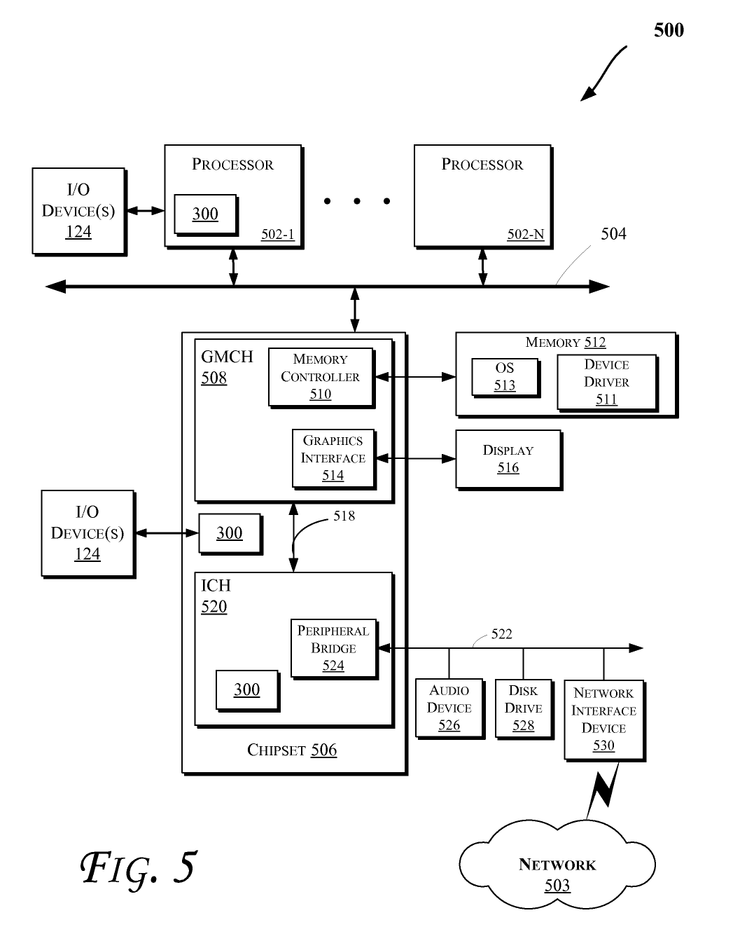

As shown in FIG. 2, each socket is coupled to a Memory Controller (MC)/Home Agent (HA) (such as MC0/HA0 through MC3/HA3). The memory controllers is coupled to a corresponding local memory (labeled as MEMO through MEM3), which can be a portion of system memory (such as memory 512 of FIG. 5). In some embodiments, the memory controller (MC)/Home Agent (HA) (such as MC0/HA0 through MC3/HA3) can be the same or similar to agent 102-1 of FIG. 1 and the memory, labeled as MEMO through MEM3, is the same or similar to memory devices discussed with reference to any of the figures herein. Generally, processing/caching agents send requests to a home node for access to a memory address with which a corresponding “home agent” is associated. Also, in one embodiment, MEMO through MEM3 can be configured to mirror data, e.g., as master and slave. Also, one or more components of system 200 can be included on the same integrated circuit die in some embodiments.

Furthermore, one implementation (such as shown in FIG. 2) is for a socket glueless configuration with mirroring. For example, data assigned to a memory controller (such as MC0/HA0) is mirrored to another memory controller (such as MC3/HA3) over the PtP links.

Some current implementations of NoCs in CMPs or System Area Networks (SANs) have various topologies, including mesh, torus, and irregular mesh toplogies. Such topologies usually feature a relatively large node connection degree (e.g., 4 in torus topology). As a result, a flow or a packet can potentially choose one of the multiple paths between a given source-destination pair. In adaptive routing, when a packet encounters a faulty or congested path, it can select another bypassing path, even it is longer in some cases. This allows for a balance of network traffic, and can potentially improve throughput and latency. However, current adaptive routing approaches generally treat all packets equally without consideration for QoS support for traffic with different service levels (priority).

As mentioned before, an NoC can be used as a shared medium connecting and servicing all cores/nodes on the chip. This means that at any point of time, there can be multiple messages of different node origins and different types being communicated. For example, some messages can be related to control signaling which have higher priority than other messages. Further, different applications can have different service level requirement (real time vs. best effort). Without losing generosity, some embodiments assume there are N classes of traffic, with priority 1 (e.g., being the highest priority), which should be delivered in very timely fashion.

Some current implementations provide QoS support for different classes by having separate queues in the router, and serving, according to the service level agreement, different queues based on priority. For example, a higher priority queue receives more serving time and is able to preempt lower priority packets. One major reason why this class of methods introduces additional separate queues is the fact that traditional router architecture is not capable of fetching packets from a single FIFO queue in an out-of-order fashion; hence, the additional dedicated per-class queues are provided. The drawback of this category of techniques is that multiple-queue support usually increases the total required buffering, which in turn increases both area (e.g., for additional queues and any supporting logic) and power consumption of the router (e.g., to operated the additional logic for the queues and their supporting logic). With the increasing number of nodes/cores in the system, this would become a severe problem. Some studies have also shown that in general the interconnect load can be relatively low, thus larger buffering may waste energy and area.

Moreover, another class of methods addresses the problem of the router not being able to fetch packets from the queues in an out-of-order fashion by foregoing the traditional, simple router architecture and introducing a sophisticated one that is capable of pulling out packets from a given queue in no particular order (i.e., without respecting their FIFO order). Although these approaches do not introduce additional buffering, they still need a complex router design that by itself consumes significant amount of power and increases the interconnect cost and area. By contrast, some embodiments provide for interconnect QoS support without requiring multiple queues nor changing the router architecture.

FIG. 3 is a block diagram of a routing and switching logic 300, in accordance with an embodiment. The logic 300 selectively deflects routing of packets for QoS support. When a packet 302 arrives at an input port 303, the routing/switching logic 304 checks the utilization of the target port (e.g., output port 306) that is associated with a destination of the received packet 302 (e.g., where the destination is identified by a destination address in a header of the packet 302 or accompanying information, etc.). If the utilization is high (e.g., at output port 306), for highest priority traffic, it can still be sent to the target port 306. However, for lower priority packets, it is more likely it will be deflected to a less utilized port (e.g., output port 308), even though this port is not the target port. Eventually, the lower priority packets will reach the destination on an alternative path, which takes more time to traverse than the minimal path. By doing so, the QoS for higher priority packets is supported.

In an embodiment, when the network is lightly loaded, all packets are routed through minimal paths to achieve minimal routing latency and energy consumption. When the utilization at certain ports increases (e.g., when compared with threshold utilization value(s), it can be based on information detected by one or more sensors proximate to the ports), the logic 304 will selectively deflect one or more lower priority packets to other ports to avoid or reduce further congestion, even if the other ports are not the ports on the minimal path to destination. This approach in turn reduces or avoids further congestion for the higher priority traffic and their timely delivery. Moreover, since this approach balances the load on different ports, higher overall network throughput can be achieved as well. To avoid live-locks (i.e., where a packet is being deflected repeatedly), the priority of packets being deflected, is gradually increased with every packet deflection. This in turn can guarantee that even for a low priority packet it will eventually be delivered to its destination, instead of being deflected endlessly.

FIG. 4 illustrates a flow diagram of a method for a selective deflection policy for QoS support, according to some embodiments. In various embodiments, the operations discussed with reference to FIG. 4 are performed by one or more of the components discussed with reference to FIGS. 1-3 and/or 5-6.

Referring to FIG. 4, when a packet is received at operation 402 and the utilization of the target port is above (or at) a certain threshold value as determined at operation 404, it indicates that some packets need to be deflected to avoid further congestion. In this case, the probability for deflecting a packet to a non-target port is calculated at operation 406, based on the following factors:

(1) utilization of the target port—the higher the utilization, the higher the deflection probability (the reason for this is to prevent saturation and congestion for the target port, and to ensure the timely delivery of the higher priority packets); and/or

(2) priority level of the packet—the lower priority packet is more likely to be deflected (while, on the other hand, a packet with higher priority is less likely to be deflected).

Accordingly, a probability-based deflection mechanism is used to provide for QoS in some embodiments. For example, the deflection probability p is calculated using the following equation:

P=a×(targetPortUutilization−utilizationThreshold)×(n/N)

where “a” is a scaling factor (can be experimentally decided), “n” is the priority of the packet [1, 2, 3, . . . ], with 1 being the highest priority, and “N” is the total number of traffic classes.

Using this equation, a lower priority packet has a higher chance to be deflected when the utilization value of the target port is higher than a threshold value. When choosing an alternate port to deflect to, the alternate port with lower utilization and one that also does not increase the hop count to the destination is considered first in an embodiment. Another important aspect is to ensure that even lower priority packets are delivered eventually to the destination, e.g., by applying an aging mechanism. For example, every time a packet is deflected as determined at operation 408, its priority is increased by a certain value at an operation 410 such that it will be less likely to be deflected at the next hop. The width of the priority increment can be a design parameter. At an operation 412, the packet is sent to a non-target port. As shown in FIG. 4, if the threshold is not met at operation 404 or the packet is not deflected at operation 408, the packet is sent to the target port at operation 414. Also, after operations 412 and 414, the method resumes at operation 402 to receive the next packet.

In one embodiment, to avoid or at least reduce the chance for live-lock a “deflection-counter” counts the number of deflection a packet encounters, and this counter value is taken into consideration when calculating the deflection probability discussed above. For example, the higher the value of the deflection counter, the lower the deflection probability. Also, even where all packets have the same priority (N=1), some embodiments still serve as a efficient and low-overhead approach to disperse congestion and achieve overall high throughput.

Furthermore, the target QoS level can be represented by assigning priority values to packets. These priority values could either have a user-level meaning or implementation (e.g., a user selected QoS level for a given application can be propagated down to the interconnect through the OS), a hardware-level meaning or implementation (e.g., the hardware gives control packets higher priority than data packets), or a combination of both.

FIG. 5 illustrates a block diagram of a computing system 500 in accordance with an embodiment of the invention. The computing system 500 includes one or more central processing unit(s) (CPUs) 502-1 through 502-N or processors (collectively referred to herein as “processors 502” or more generally “processor 502”) that communicate via an interconnection network (or bus) 504. The processors 502 includes a general purpose processor, a network processor (that processes data communicated over a computer network 503), or other types of a processor (including a reduced instruction set computer (RISC) processor or a complex instruction set computer (CISC)). Moreover, the processors 502 has a single or multiple core design. The processors 502 with a multiple core design can integrate different types of processor cores on the same integrated circuit (IC) die. Also, the processors 502 with a multiple core design can be implemented as symmetrical or asymmetrical multiprocessors.

Also, the operations discussed with reference to FIGS. 1-4 can be performed by one or more components of the system 500. In some embodiments, the processors 502 can be the same or similar to the processors 202-208 of FIG. 2. Furthermore, the processors 502 (or other components of the system 500) includes one or more routing and switching logic 300. Moreover, even though FIG. 5 illustrates some locations for logic 300, these components can be located elsewhere in system 500. For example, I/O device(s) 124 communicate via bus 522 through logic 300.

A chipset 506 also communicates with the interconnection network 504. The chipset 506 includes a graphics and memory controller hub (GMCH) 508. The GMCH 508 includes a memory controller 510 that communicates with a memory 512. The memory 512 stores data, including sequences of instructions that are executed by the CPU 502, or any other device included in the computing system 500. For example, the memory 512 stores data corresponding to an operation system (OS) 513 and/or a device driver 511 as discussed with reference to the previous figures. In an embodiment, the memory 512 and memory 140 of FIG. 1 can be the same or similar. In one embodiment of the invention, the memory 512 can include one or more volatile storage (or memory) devices such as random access memory (RAM), dynamic RAM (DRAM), synchronous DRAM (SDRAM), static RAM (SRAM), or other types of storage devices. Nonvolatile memory can also be utilized such as a hard disk. Additional devices can communicate via the interconnection network 504, such as multiple CPUs and/or multiple system memories.

Additionally, in some embodiments, one or more of the processors 502 have access to one or more caches (which can include private and/or shared caches in various embodiments) and associated cache controllers (not shown). The cache(s) can adhere to one or more cache coherent protocols. The cache(s) store data (e.g., including instructions) that are utilized by one or more components of the system 500. For example, the cache locally caches data stored in a memory 512 for faster access by the components of the processors 502. In an embodiment, the cache (that can be shared) can include a mid-level cache and/or a last level cache (LLC). Also, each processor 502 includes a level 1 (L1) cache. Various components of the processors 502 communicate with the cache directly, through a bus or interconnection network, and/or a memory controller or hub.

The GMCH 508 also includes a graphics interface 514 that communicates with a display device 516, e.g., via a graphics accelerator. In one embodiment of the invention, the graphics interface 514 can communicate with the graphics accelerator via an accelerated graphics port (AGP). In an embodiment of the invention, the display 516 (such as a flat panel display) can communicate with the graphics interface 514 through, for example, a signal converter that translates a digital representation of an image stored in a storage device such as video memory or system memory into display signals that are interpreted and displayed by the display 516. The display signals produced by the display device pass through various control devices before being interpreted by and subsequently displayed on the display 516.

A hub interface 518 allows the GMCH 508 and an input/output control hub (ICH) 520 to communicate. The ICH 520 provides an interface to I/O devices that communicate with the computing system 500. The ICH 520 communicates with a bus 522 through a peripheral bridge (or controller) 524, such as a peripheral component interconnect (PCI) bridge, a universal serial bus (USB) controller, or other types of peripheral bridges or controllers. The bridge 524 provides a data path between the CPU 502 and peripheral devices. Other types of topologies can be utilized. Also, multiple buses can communicate with the ICH 520, e.g., through multiple bridges or controllers. Moreover, other peripherals in communication with the ICH 520 include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 522 communicates with an audio device 526, one or more disk drive(s) 528, and a network interface device 530 (which is in communication with the computer network 503). Other devices communicate via the bus 522. Also, various components (such as the network interface device 530) can communicate with the GMCH 508 in some embodiments of the invention. In an embodiment, the processor 502 and one or more components of the GMCH 508 and/or chipset 506 are combined to form a single integrated circuit chip (or be otherwise present on the same integrated circuit die).

Furthermore, the computing system 500 can include volatile and/or nonvolatile memory (or storage). For example, nonvolatile memory includes one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

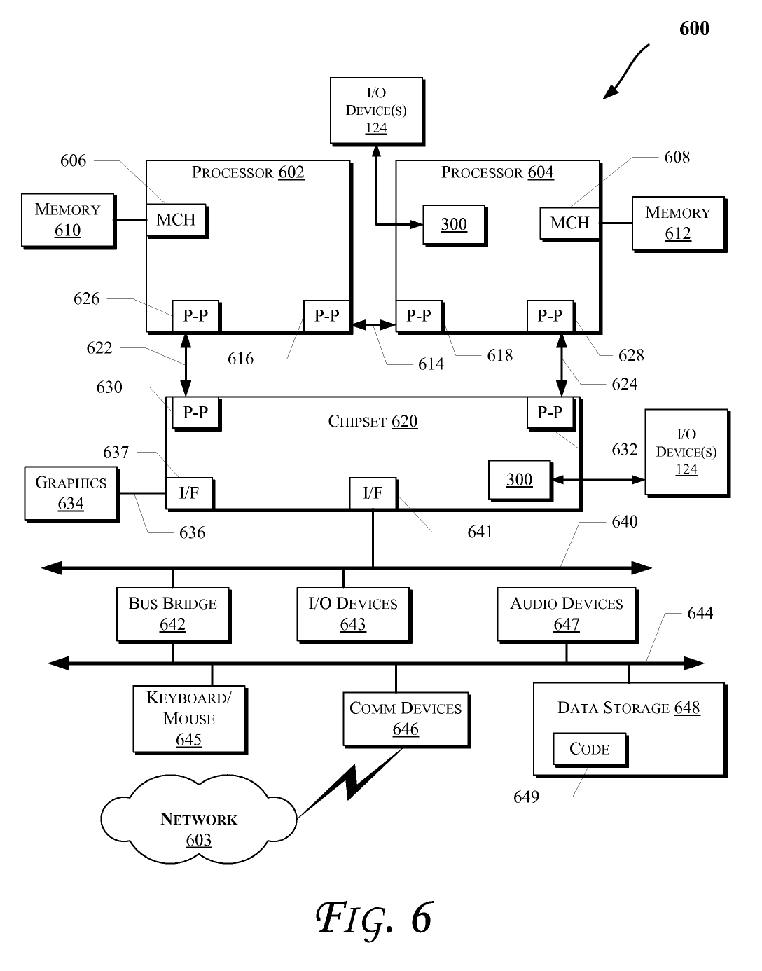

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-5 are performed by one or more components of the system 600.

As illustrated in FIG. 6, the system 600 includes several processors, of which only two, processors 602 and 604 are shown for clarity. The processors 602 and 604 each include a local memory controller hub (MCH) 606 and 608 to enable communication with memories 610 and 612. The memories 610 and/or 612 store various data such as those discussed with reference to the memory 512 of FIG. 5. In an embodiment, the processors 602 and 604 also include the cache(s) discussed with reference to FIG. 5.

In an embodiment, the processors 602 and 604 can be one of the processors 502 discussed with reference to FIG. 5. The processors 602 and 604 exchange data via a point-to-point (PtP) interface 614 using PtP interface circuits 616 and 618, respectively. Also, the processors 602 and 604 each exchange data with a chipset 620 via individual PtP interfaces 622 and 624 using point-to-point interface circuits 626, 628, 630, and 632. The chipset 620 further exchanges data with a high-performance graphics circuit 634 via a high-performance graphics interface 636, e.g., using a PtP interface circuit 637.

At least one embodiment of the invention is provided within the processors 602 and 604 or chipset 620. For example, the processors 602 and 604 and/or chipset 620 include one or more routing and switching logic 300. Other embodiments of the invention, however, can exist in other circuits, logic units, or devices within the system 600 of FIG. 6. Furthermore, other embodiments of the invention can be distributed throughout several circuits, logic units, or devices illustrated in FIG. 6. Hence, location of logic 300 shown in FIG. 6 is exemplary and such components may or may not be provided in the illustrated locations.

The chipset 620 communicates with a bus 640 using a PtP interface circuit 641. The bus 640 has one or more devices that communicate with it, such as a bus bridge 642 and I/O devices 643. Via a bus 644, the bus bridge 642 communicate with other devices such as a keyboard/mouse 645, communication devices 646 (such as modems, network interface devices, or other communication devices that communicate through the computer network 503), audio I/O device, and/or a data storage device 648. The data storage device 648 stores code 649 that may be executed by the processors 602 and/or 604.

In various embodiments of the invention, the operations discussed herein, e.g., with reference to FIGS. 1-6, can be implemented as hardware (e.g., circuitry), software, firmware, microcode, or combinations thereof, which may be provided as a computer program product, e.g., including a (e.g., non-transitory) machine-readable or (e.g., non-transitory) computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-6. Additionally, such computer-readable media may be downloaded as a computer program product, wherein the program may be transferred from a remote computer (e.g., a server) to a requesting computer (e.g., a client) by way of data signals transmitted via a carrier wave or other propagation medium via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
logic to determine whether a target port of a packet has reached a threshold utilization value; and
logic to route the packet to an alternate port in response to a deflection probability value to be determined based on a utilization value of the target port and a priority level value of the packet.

2. The apparatus of claim 1, wherein the target port corresponds to a minimal path for the packet to reach a destination of the packet.

3. The apparatus of claim 2, wherein the destination is to be included in a header of the packet.

4. The apparatus of claim 1, wherein the logic to route the packet is to select the alternate port based on one of: a utilization value of the alternate port and a number of hops to a destination of the packet.

5. The apparatus of claim 1, wherein the deflection probability value is to be determined based on a number of deflections of the packet.

6. The apparatus of claim 1, further comprising logic to modify the priority level value of the packet in response to a determination that the packet is to be routed to the alternate port.

7. The apparatus of claim 1, wherein the target port is to be coupled to a link to transmit the packet.

8. The apparatus of claim 8, wherein the link is to couple a first agent to a second agent, wherein the second agent is to comprise an input/output device.

9. The apparatus of claim 8, wherein the link is to comprise a point-to-point coherent interconnect.

10. The apparatus of claim 8, wherein the link is to couple a first agent to a second agent, wherein the first agent is to comprise a plurality of processor cores and one or more sockets.

11. The apparatus of claim 8, wherein the link is to couple a first agent to a second agent, wherein one or more of the first agent, the second agent, and a memory are on a same integrated circuit chip.

12. The apparatus of claim 8, wherein the link comprises a Peripheral Component Interconnect Express (PCIe) link.

13. The apparatus of claim 1, further comprising an input port to receive the packet over a link.

14. The apparatus of claim 14, wherein the link is to couple a first agent to a second agent, wherein the second agent is to comprise an input/output device.

15. The apparatus of claim 14, wherein the link is to comprise a point-to-point coherent interconnect.

16. The apparatus of claim 14, wherein the link is to couple a first agent to a second agent, wherein the first agent is to comprise a plurality of processor cores and one or more sockets.

17. The apparatus of claim 14, wherein the link is to couple a first agent to a second agent, wherein one or more of the first agent, the second agent, and a memory are on a same integrated circuit chip.

18. The apparatus of claim 14, wherein the link comprises a Peripheral Component Interconnect Express (PCIe) link.

19. A method comprising:
determining whether a target port of a packet has reached a threshold utilization value; and
routing the packet to an alternate port in response to a deflection probability value to be determined based on a utilization value of the target port and a priority level value of the packet.

20. The method of claim 19, further comprising selecting the alternate port based on one of: a utilization value of the alternate port and a number of hops to a destination of the packet.

21. The method of claim 19, comprising determining the deflection probability value based on a number of prior deflections of the packet.

22. A computing system comprising:
a routing and switching logic to be capable of coupling a first agent and a second agent via a link, the routing and switching logic to comprise:
logic to determine whether a target port of a packet in the routing and switching logic has reached a threshold utilization value; and
logic to route the packet to an alternate port of the routing and switching logic in response to a deflection probability value to be determined based on a utilization value of the target port and a priority level value of the packet.

23. The system of claim 22, wherein the logic to route the packet is to select the alternate port based on one of: a utilization value of the alternate port and a number of hops to a destination of the packet.

24. The system of claim 22, wherein the deflection probability value is to be determined based on a number of prior deflections of the packet.

25. The system of claim 22, wherein the priority level value of the packet is to be modified in response to a determination that the packet is to be routed to the alternate port.

26. The system of claim 22, wherein the link is to comprise a point-to-point coherent interconnect.

27. The system of claim 22, wherein the link comprises a Peripheral Component Interconnect Express (PCIe) link.

28. A non-transitory computer-readable medium comprising one or more instructions that when executed on a processor configure the processor to perform one or more operations to:
determine whether a target port of a packet has reached a threshold utilization value; and
route the packet to an alternate port in response to a deflection probability value to be determined based on a utilization value of the target port and a priority level value of the packet.

29. The non-transitory computer-readable medium of claim 28, further comprising instructions that when executed on the processor configure the processor to select the alternate port based on one of: a utilization value of the alternate port and a number of hops to a destination of the packet.

30. The non-transitory computer-readable medium of claim 28, further comprising instructions that when executed on the processor configure the processor to determine the deflection probability value based on a number of prior deflections of the packet.

31. An apparatus comprising:
utilization logic to determine a utilization metric associated with a first port; and
routing logic configured to route a first packet associated with the first port based on a minimal path to the first port in response to the utilization metric being below a utilization threshold, and to deflect a second packet associated with the first port based on a minimal path to a second port in response to the utilization metric exceeding the utilization threshold and the second packet being associated with a priority level below a threshold priority level.

32. The processor of claim 31, further comprising control logic to increase the threshold priority level in response to the routing logic deflecting the second packet associated with the first port to the second port.

33. The processor of claim 31, wherein the first port and the second port are to be coupled via a link.

34. The processor of claim 33, wherein the link is to couple a first agent to a second agent, wherein the second agent is to comprise an input/output device.

35. The processor of claim 33, wherein the link is to comprise a point-to-point coherent interconnect.

36. The processor of claim 33, wherein the link is to couple a first agent to a second agent, wherein the first agent is to comprise a plurality of processor cores and one or more sockets.
